(19) United States
(12) Patent Application Publication
(10) Pub. No.: US 2006/0282861 A1
(43) Pub. Date: Dec. 14, 2006

(54) Audio/video expansion device and vehicular audio/video system using the same

(76) Inventors: Ming-Feng Chen, Taipei (TW); Chia-Tzu Hu, Yunlin County (TW); Feng-Ching Chiu, Taoyuan County (TW)

Correspondence Address: BACON & THOMAS, PLLC, 625 SLATERS LANE, FOURTH FLOOR, ALEXANDRIA, VA, 22314, US

(21) Appl. No.: 11/443,053

(22) Filed: May 31, 2006

(30) Foreign Application Priority Data
Jun. 9, 2005 (TW) 094209647

(51) Int. Cl. H04N 7/18

(52) U.S. Cl. 725/75; 725/74

(57) ABSTRACT

A vehicular audio/video system according to the present invention comprises: an expansion device for generating an output signal; an output device for receiving the output signal; an optical disc device for generating a first input signal to the expansion device; a detachable media storage device for generating a media data to the expansion device which processes the media data into a second input signal; and a handheld communication device for generating a communication data to the expansion device which processes the communication data into a third input signal. The expansion device selects the first input signal to be the output signal under an optical disc mode, selects the second input signal to be the output signal a media play mode, and selects the third input signal to be the output signal under a communication mode.

### BACKGROUND OF THE INVENTION

1. Field of the Invention

The present invention relates to vehicular audio/video techniques, more particularly, the present invention relates to an audio/video expansion device and vehicular system using the same.

2. Discription of the Related Art

With the technology advancement of audio/video techniques, people have a wider selection of entertainments. Home theater audio/video system is an example of such development, by which people enjoy entertaining experience of higher quality. It is followed by a demand for audio/video performance of higher quality when people driving cars. Audio/video devices such as a CD player, VCD player, DVD player and LCD TV are equipped as standard devices in a vehicle. In addition, detachable media storage devices such as iPod by Apple Computers and multimedia cellular phone have become popular devices in daily life. A strong demand of expanding vehicular audio/video applications is triggered among car users. However, typically a standard audio/video system in a car is configured when the car is assembled in a factory. When a user desires to expand the audio/video system in a car, the change requires complicated and expensive procedure and as a result, the user maybe deterred by the effort and cost required for expanding the audio/video system in the car.

Therefore, alternatives are desired to integrate an optical disc changer, detachable media storage device and handheld communication device in a vehicular audio/video system.

### SUMMARY OF THE INVENTION

It is an object of the present invention to provide an expansion device and vehicular audio/video system using the same without changing the hardware configuration of the original stereo system and integrating an optical disc changer, a detachable media storage device and a handheld communication device into the vehicular audio/video system.

To obtain the above object, the present invention is to provide a vehicular audio/video system. The vehicular audio/video system according to the present invention comprises: an expansion device for generating an output signal; an output device for receiving the output signal; an optical disc device for generating a first input signal to the expansion s device; a detachable media storage device for generating a media data to the expansion device which processes the media data into a second input signal; a handheld communication device for generating a communication data to the expansion device which processes the communication data into a third input signal, wherein the expansion device selects the first input signal to be the output signal under an optical disc mode, selects the second input signal to be the output signal under a media play mode, and selects the third input signal to be the output signal under a communication mode.

In addition, the present invention is to provide an audio/video expansion device applying to a vehicular audio/video system. The vehicular audio/video system comprises an input device, an optical disc device, a detachable media storage device and a handheld communication device. The audio/video expansion device comprises: a selector for receiving a first input signal generated by the optical disc device; a media control module for receiving a media data generated by the detachable media storage device and converting the media data into a second input signal to send to the selector; a communication control module for receiving a communication data generated by the handheld communication device and converting the communication data into a third input signal to send to the selector; and a micro controller for controlling the selection of the input signal among the first input signal and the second input signal and the third input signal.

### BRIEF DESCRIPTION OF THE DRAWINGS

FIG. 1 is a block diagram to illustrate a preferred embodiment in the vehicular audio/video system according to the present invention; and

FIG. 2 is a control flow chart according to the present invention.

### DETAILED DESCRIPTION OF THE PREFERRED EMBODIMENTS

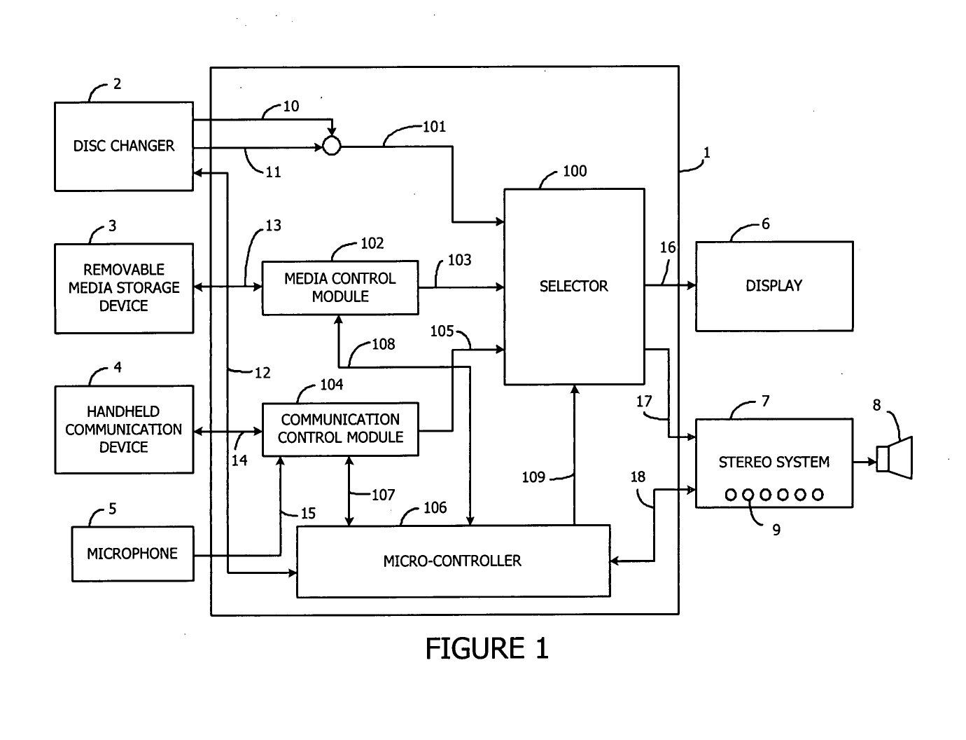

Refers to FIG. 1, it is a schematic block diagram to illustrate a preferred embodiment in the vehicular audio/video system according to the present invention. As shown in the FIG. 1, the vehicular audio/video system according to the present invention comprises: an audio/video expansion device 1, an optical disc changer 2, a detachable media storage device 3, a handheld communication device 4, a microphone 5, a monitor 6, a stereo system 7, and a speaker 8. The audio/video expansion device 1 according to the present invention is separately connected to the optical disc changer 2, the detachable media storage device 3, the handheld communication device 4, the microphone 5, the monitor 6, and the stereo system 7. The stereo system 7 is connected to the speaker 8.

The optical disc changer 2 is an optical disc player integrated with multiple disc changing mechanism, where the optical disc player can be a compact disc player and an audio/video player such as a video compact disc (VCD) player and a digital versatile disc (DVD) player. If the optical disc changer 2 is an audio/video player, the optical disc changer 2 generates a video signal 10 and an audio signal 11 to send to the audio/video expansion device 1 under the playing mode. If the optical disc changer 2 is an audio player, then the optical disc changer 2 does not generate the video signal 10, but the audio signal 11 only. In addition, the optical disc changer 2 communicates control codes with the audio/video expansion device 1 via a control bus 12.

The detachable media storage device 3 can be an electrically erasable programmable read only memory, a flash memory, a hard disc, a magnetic tape, an electrical storage device or a magnetic storage device. Digital audio and/or video data is recorded in the detachable media storage device 3. The digital audio and/or video data is sent to the audio/video expansion device 1 for data processing via a data bus 13. The data bus 13 can be a standard interface based on the following protocols: universal serial bus (USB), IEEE 1394, SCSI, IDE, PCMCIA, PCI.

The handheld communication device 4 can be a cellular phone based on Global System for Mobile Communications (GSM) or Third Generation wireless data transmission technology. The handheld communication device 4 communicates with the audio/video expansion device 1 via a bus 14. If the handheld communication device 4 is a cellular phone with a Bluetooth data transmission interface, then the audio/video expansion device 1 is installed with a Bluetooth data transmission control chip such that the physical bus 14 is not required in such embodiment. The handheld communication device 4 communicates with audio/video expansion device 1 via the Bluetooth wireless data transmission protocol. In addition, the microphone 5 is installed in a car, the voice of a car user is sent to the audio/video expansion device 1 via an audio signal cable 15. In such embodiment, the car user can use a cellular phone without wearing earphones when driving a car.

The monitor 6 is used for receiving and displaying an output video signal 16 generated by the audio/video expansion device 1. The monitor 6 can be one of the following display devices: a cathode ray tube TV, a liquid crystal display TV, a plasma TV, a LED TV, an organic LED TV or a field emission display TV.

The stereo system 7 comprises audio processing circuits such as an AM/FM tuner, a cassette player, an amplifier and a crossover. The stereo system 7 processes audio signals from the tuner and cassette player, as well as the input audio signal 17 generated by the audio/video expansion device 1, and the audio signals are sent and output to the speaker 8. The stereo system 7 communicates with the audio/video expansion device 1 via a control bus 18. The car user presses a control button 9 installed on the stereo system 7 to switch operation modes of the vehicular audio/video expansion device 1. Such operation modes include stereo system mode, disc changer mode, detachable media storage mode or communication mode, which are detailed in the following.

The audio expansion device 1 of a prior art vehicular audio/video system is connected to the optical disc changer 2 directly. The stereo system 7 communicates with the optical disc changer 2 via the control bus. Therefore, when the car user selects to operate under optical disc changer mode with the stereo system 7, an enable signal is sent from the stereo system 7 to initiate the operation of the optical disc changer 2, the audio signal 10 then is sent and output to the stereo system 7. According to the present invention, via the audio/video expansion device 1, the operation mode can be switched among optical disc changer mode, detachable media storage mode or communication mode, without any required changes of the hardware configuration of the stereo system 7, the optical disc changer 2, the detachable media storage 3, and the handheld communication device 4. Accordingly, the stereo system 7 is not required to determine the audio signal 17 is sent from the optical disc changer 2, the detachable media storage 3, or the handheld communication device 4. The audio/video expansion device 1 communicates with the stereo system 7 via the control bus 18. In addition, the car user is allowed to select via the audio/video expansion device 1 to output the video output signal 16 or audio output signal 17 from the optical disc changer 2, the detachable media storage 3, or the handheld communication device 4.

Referring to FIG. 1, the audio/video expansion device 1 comprises: a selector 100, a media control module 102, a communication control module 104, and a micro controller 106. As shown in the FIG. 1, the audio/video expansion device 1 receives the video signal 10 and the audio signal 11 from the optical disc changer 2. The video signal 10 and the audio signal 11 are input to the selector 100 as an input audio/video signal 101. The media control module 102 retrieves the media data from the detachable media storage device 3 via the data bus 13. The media data is processed and input to the selector 100 as an input media signal 103. For example, a MP3 decoder and a digital/analogue converter are configured in the media control module 102, then the MP3 decoder and the digital/analogue converter are used for processing and converting digital audio data into analog audio signals. In addition, an MPEG4 decoder is configured into the media control module 102, and then the Mpeg4 decoder is used for processing and converting the digital audio/video data into analog audio/video signals. In addition, the data transmission protocol used by the detachable media storage device 3 has to coincide with the data transmission protocol used by the media control module 2, for example, the detachable media storage device 3 is an USB storage device, then the media control module 2 is a USB controller.

The communication module 104 receives a voice signal from the microphone 5 and inputs the voice signal to the selector 100 as an input communication signal 105. If the handheld communication device 4 is a cellular phone using Third Generation wireless data transmission protocol, then the audio/video data is processed by communication control module 104 upon receipt of the audio/video data at the handheld communication device 4. The processed audio/video data is input to the selector 100 as an input communication signal 105. The selector 100 selects the input audio/video signal 101, the input media signal 103, and input communication signal 105 and provides the output video signal 16 and the output audio signal 17. The output video signal 16 and the output audio signal 17 are output to the monitor 6 and stereo system 7 respectively.

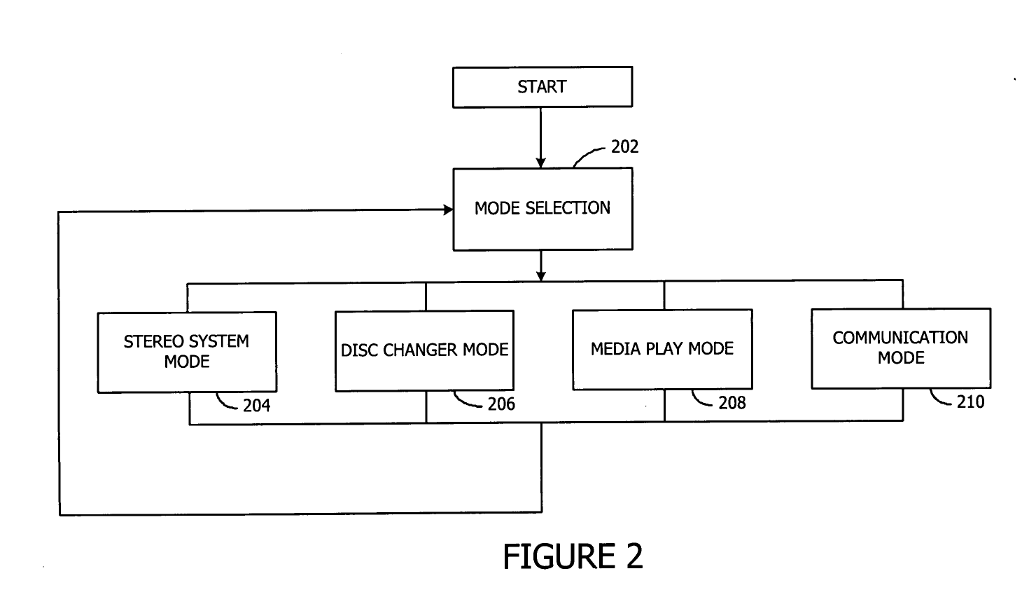

The micro controller 106 is in charge of controlling operation of the audio/video expansion device 1. The micro controller 106 is connected to the optical disc changer 2 and the stereo system 7 via the control bus 12 and control bus 18 respectively. The micro controller 106 is connected to the communication control module 104 via a control bus 107. The micro controller 106 is connected to the media control module via a control bus 108. The micro controller 106 is connected to the selector 100 via a control bus 109. Referring to FIG. 2, a control flow chart according to the present invention is illustrated. As shown in the FIG. 2, at step 202, a car user selects an operation mode with the stereo system 7. According to the operation mode selected by the car user, the operation enters into one of the following operation modes: a stereo system mode (as shown at step 204), a disc changer mode (as shown at step 206), a media play mode (as shown at step 208), and a communication mode (as shown at step 210). The car user is allowed to switch to other operation modes by pressing the control button 9 on the stereo system 7. The detailed operating steps of the stereo system mode, the disc changer mode, and the media play mode, and the communication mode are described in the following.

Stereo System Mode

Under the stereo system mode, the stereo system 7 outputs audio signals from a tuner or a cassette player to the speaker 8. The stereo system mode is a default function delivered by the stereo system 7 and detailed operation is omitted.

Disc Changer Mode

The stereo system 7 sends a control signal via the control bus 18 for controlling the mode switching between a stereo system 7 from different makers and the optical disc changer 2. The control signal is sent to and converted by the micro controller 106 of the audio/video expansion device 1 into control codes for controlling the optical disc changer 2. The control codes are sent to the optical disc changer 2 via the control bus 12. The optical disc changer 2 outputs the video signal 10 and the audio signal 11 as the input audio/video signal 101. The control signal 109 is sent from the micro controller 106 for controlling the selector 100. According to the control signal 109, the selector 100 selects and outputs the input audio/video signal 101 to the monitor 6 and the stereo system 7.

Media Play Mode

Under the media play mode, the stereo system 7 sends a control signal via the control bus 18 to the micro controller 106 of the audio/video expansion device 1. The micro controller 106 converts the control signal into control codes for controlling the media control module 102. The control codes are sent to the media control module 102 via the control bus 108. According to the control codes, the media control module 102 retrieves the digital data in the detachable media storage device 3. The digital data is processed and converted by the media control module 102 into the input media signal 103. The micro controller 106 sends the control signal 109 to the selector 100. According to the control signal 109, the selector selects and converts the input media signal 103 into the output video signal 16 and the output audio signal 17. The output video signal 16 and the output audio signal 17 are thereafter output to the monitor 6 and the stereo system 7.

Communication Mode

When the handheld communication device 4 receives a phone call, the communication control module 104 sends a signal to inform the micro controller 106 about the receipt of the phone call via the control bus 107. The micro controller 106 sends a signal to the stereo system 7 via the control bus 18. The car user decides whether to take the phone call. If yes, the control signal is sent to the micro controller 106 via the control bus 18. The micro controller 106 outputs the control signal 109 for controlling the selector 100. According to the control signal 109, the selector 100 selects and converts the input communication signal 105. The input communication signal 105 is converted as the output video signal 16 and the output audio signal 17 is output to the microphone 5. By which, the car user is allowed to answer the phone call under a hand-free mode. If the handheld communication device 4 is enabled functions of transmitting or audio/video data storage, then the input communication signal further includes audio and video signals, where the selector 100 selects them to be the output video signal 16 and output audio signal 17. The output video signal 16 and output audio signal 17 are sent to the monitor 6 and the stereo system 7, respectively.

According to the above, audio/video signal sources are added by integrating the detachable media storage device 3 and the handheld communication device 4 into the vehicular audio/video system without changes made to the wiring of the stereo system 7 and the optical disc changer 2.

Based on the accompanying drawings, practical embodiments according to the present invention have been described. However, the present invention is not limited to the illustrated method. It will be apparent to those skilled in the art that various changes, improvements, and modifications can be made thereto without departing from the spirit or scope of the invention.

What is claimed is:

1. A vehicular audio/video system, comprises:
an expansion device for generating an output signal;
an output device for receiving the output signal;
an optical disc device for generating a first input signal to the expansion device;
a detachable media storage device for generating a media data to the expansion device which processes the media data into a second input signal; and
a handheld communication device for generating a communication data to the expansion device which processes the communication data into a third input signal;
wherein, the expansion device selects the first input signal to be the output signal under an optical disc mode, selects the second input signal to be the output signal under a media play mode, and selects the third input signal to be the output signal under a communication mode.

2. The vehicular audio/video system as claimed in claim 1, wherein the output signal, the first input signal and the second input signal are audio signals.

3. The vehicular audio/video system as claimed in claim 2, wherein the output device is a stereo player.

4. The vehicular audio/video system as claimed in claim 1, wherein the output signal, the first input signal and the second input signal are video signals.

5. The vehicular audio/video system as claimed in claim 4, wherein the output device is a monitor.

6. The vehicular audio/video system as claimed in claim 1, wherein the expansion device comprises:
a micro controller fro generating a control signal;
a media control module for converting the media data into the second input signal;
a communication control module for converting the communication data into the third input signal; and
a selector for selecting the input signal among the first input signal and the second input signal and the third input signal according to the control signal from the micro controller.

7. The vehicular audio/video system as claimed in claim 6, further comprising a microphone connected to the communication control module for receiving a user's voice.

8. The vehicular audio/video system as claimed in claim 6, wherein the selector is an analog switch.

9. An expansion device applying to a vehicular audio/video system comprising an output device, an optical disc device, a detachable media storage device and a handheld media communication device; the expansion device comprising:
a selector for receiving a first input signal generated by the optical disc device;
a media control module for receiving a media data generated by the detachable media storage device and converting the media data into a second input signal to send to the selector;
a communication control module for receiving a communication data generated by the handheld communication device and converting the communication data into a third input signal to send to the selector; and
a micro controller for controlling the selection of the input signal among the first input signal and the second input signal and the third input signal.

10. The expansion device as claimed in claim 9, wherein the output signal, the first input signal and the second input signal are audio signals.

11. The expansion device as claimed in claim 10, wherein the output device is a stereo player.

12. The expansion device as claimed in claim 9, wherein the output signal, the first input signal and the second input signal are video signals.

13. The expansion device as claimed in claim 12, wherein the output device is a monitor.

14. The expansion device as claimed in claim 9, further comprises a microphone connected to the communication module for receiving a user's voice.

15. The expansion device as claimed in claim 9, wherein the selector is an analog switch.
